(19) United States
(12) Patent Application Publication
(10) Pub. No.: US 2012/0203599 A1
(43) Pub. Date: Aug. 9, 2012

(54) METHOD AND APPARATUS FOR PROVIDING A SAFE TAXI SERVICE

(75) Inventors: Woo-Jun CHOI, Hwaseong-si (KR); Kwang-Hyuk KIM, Suwon-si (KR)

(73) Assignee: Samsung Electronics Co., Ltd., Suwon-si (KR)

(21) Appl. No.: 13/368,827

(22) Filed: Feb. 8, 2012

(30) Foreign Application Priority Data
Feb. 8, 2011 (KR) 10-2011-0010879

(51) Int. Cl. G06Q 50/30

(52) U.S. Cl. 705/13

(57) ABSTRACT

A management server authenticates taxi drivers, searches for taxis near a taxi user, calls a taxi, searches for and tracks a taxi upon an emergency call from a taxi user, and updates assessment information about the services provided by taxi drivers. A taxi driver may undergo authentication on the taxi driver himself and his taxi before driving the taxi by putting his mobile terminal on a terminal holder mounted in the taxi upon a ride in the taxi. Before taking a ride in a taxi, a taxi user may receive driver information about taxis from the management server using a mobile terminal, and select a taxi after checking the received driver information.

### PRIORITY

This application claims priority under 35 U.S.C. §119(a) to a Korean Patent Application Serial No. 10-2011-0010879, which was filed in the Korean Intellectual Property Office on Feb. 8, 2011, the entire disclosure of which is hereby incorporated by reference.

### BACKGROUND OF THE INVENTION

1. Field of the Invention

The present invention relates generally to a method and apparatus for providing a taxi service, and more particularly, to a method and apparatus for providing a safe and convenient taxi service using a mobile terminal.

2. Description of the Related Art

To prevent danger during taxi travel for both passengers and taxi drivers, e.g., criminal and driving related, a security service has been proposed, which notifies a rider's family of a ride in a taxi using Short Message Service (SMS) when in the rider enters the taxi, and notifies the family when the rider gets out of the taxi.

However, the security service that notifies the rider's getting in and out of the taxi using an SMS message is sent only after the rider already gets in the taxi, making it impossible to provide information about the taxi driver to the family in advance, i.e., before entering the taxi. Consequently, the rider may still be exposed to dangers because this service cannot well cope with possible crimes.

As there are number of safety concerns regarding taxi travel for both passengers and taxi drivers, e.g., criminal and driving related, a need exists for a safer taxi service.

### SUMMARY OF THE INVENTION

Accordingly, the present invention is designed to address at least the problems and/or disadvantages described above and to provide at least the advantages described below.

An aspect of the present invention is to provide a taxi service method and apparatus that assist users in avoiding crimes.

Another aspect of the present invention is to provide a taxi service method and apparatus that allow a service user to acquire information about a taxi driver before riding in the taxi.

Another aspect of the present invention is to provide a taxi service method and apparatus for a service user to feed back information about a taxi driver after a taxi ride.

In accordance with an aspect of the present invention, a method for providing a taxi service is provided. The method includes sending, by a user mobile terminal, a search request message for a taxi; receiving, from a management server, a driver information message including a vehicle number of a taxi and assessment information about a service provided by a driver of the taxi; and displaying the vehicle number and the assessment information for the taxi.

In accordance with another aspect of the present invention, another method for providing a taxi service is provided. The method includes connecting a driver mobile terminal to a terminal holder mounted in a taxi through short-range communication; authenticating a driver of the taxi based on the driver mobile terminal; and receiving a taxi search request message.

In accordance with another aspect of the present invention, a method for providing a taxi service in a management server managing information about a taxi and a driver thereof is provided. The method includes receiving a taxi search request message from a user mobile terminal; determining radial coordinates centered on a location of the user mobile terminal; sending the taxi search request message including the radial coordinates to a driver mobile terminal connected to the taxi; receiving, from the driver mobile terminal, a taxi information message including location information of the driver mobile terminal, identification information of the driver mobile terminal, and a vehicle number of the taxi; acquiring assessment information about a service provided by the driver of the taxi based on the identification information of the driver mobile terminal and the vehicle number; and sending, to the user mobile terminal, a driver information message including the assessment information, the identification information of the driver mobile terminal, the vehicle number of the taxi, and the location information of the driver mobile terminal.

In accordance with another aspect of the present invention, a user mobile terminal providing a taxi service is provided. The user mobile terminal includes a wireless communication unit for performing communication with a management server; a display for displaying data; and a controller for controlling the wireless communication unit and the display, generating a search request message for a taxi, sending the search request message through the wireless communication unit, receiving, from the management server through the wireless communication unit, a driver information message including a vehicle number of a taxi and assessment information about a service provided by a driver of the taxi, and displaying the vehicle number and the assessment information for the taxi on the display.

In accordance with another aspect of the present invention, a mobile terminal providing a taxi service is provided. The driver mobile terminal includes a short-range communication module for performing short-range communication; a wireless communication unit for performing communication with a management server; a Global Positioning System (GPS) module for detecting a location of the driver mobile terminal; a display for displaying data; and a controller for controlling the short-range communication module, the wireless communication unit, the GPS module, and the display, connecting the driver mobile terminal to a terminal holder mounted in a taxi through the short-range communication module, authenticating a driver of the taxi based on the driver mobile terminal, and upon receiving a taxi search request message, generating a taxi information message including a vehicle number of the taxi and identification information of the driver mobile terminal.

In accordance with another aspect of the present invention, a management server is provided for managing information about a taxi and a driver thereof. The management server includes a communication unit for performing communication; a memory for storing data; and a controller for controlling the communication unit, receiving a taxi search request message from a user mobile terminal through the communication unit, determining radial coordinates centered on a location of the user mobile terminal, sending the taxi search request message including the radial coordinates to a driver mobile terminal connected to the taxi through the communication unit, receiving a taxi information message including location information of the driver mobile terminal, identification information of the driver mobile terminal, and a vehicle number of the taxi from the driver mobile terminal through the communication unit, acquiring assessment information about a service provided by the driver of the taxi based on the identification information of the driver mobile terminal and the vehicle number, generating a driver information message including the assessment information, the identification information of the driver mobile terminal, the vehicle number of the taxi, and the location information of the driver mobile terminal, and sending the driver information message to the user mobile terminal through the communication unit.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a mobile terminal according to an embodiment of the present invention;

FIG. 2 is a block diagram illustrating a terminal holder according to an embodiment of the present invention;

FIG. 3 is a block diagram illustrating a management server according to an embodiment of the present invention;

FIG. 4 is a block diagram illustrating a driver information server according to an embodiment of the present invention;

FIG. 5 is a signal flow diagram illustrating taxi driver authentication and driving preparation processes according to an embodiment of the present invention;

FIG. 6 illustrates a waiting state selection screen of a user terminal according to an embodiment of the present invention;

FIG. 7 illustrates nearby taxi search screens according to an embodiment of the present invention;

FIG. 8 is a signal flow diagram illustrating a nearby taxi search process according to an embodiment of the present invention;

FIG. 9 illustrates detailed taxi information screens according to an embodiment of the present invention;

FIG. 10 illustrates faraway taxi search screens according to an embodiment of the present invention;

FIG. 11 is a signal flow diagram illustrating a faraway taxi search process according to an embodiment of the present invention;

FIG. 12 illustrates recommended taxi search screens according to an embodiment of the present invention;

FIG. 13 is a signal flow diagram illustrating a recommended taxi search process according to an embodiment of the present invention;

FIG. 14 illustrates a taxi selection/call screens according to an embodiment of the present invention;

FIG. 15 is a signal flow diagram illustrating a taxi call process according to an embodiment of the present invention;

FIG. 16 illustrates screens for location tracking and boarding checking, after a taxi call, according to an embodiment of the present invention;

FIG. 17 is a signal flow diagram illustrating a taxi driving termination process according to an embodiment of the present invention;

FIG. 18 illustrates emergency mode screens according to an embodiment of the present invention;

FIG. 19 is a signal flow diagram illustrating a process of tracking a taxi in case of an emergency according to an embodiment of the present invention;

FIG. 20 is a signal flow diagram illustrating a driver assessment process according to an embodiment of the present invention; and

FIG. 21 illustrates driver assessment screens according to an embodiment of the present invention.

### DETAILED DESCRIPTION OF EMBODIMENTS OF THE INVENTION

Various embodiments of the present invention will now be described in detail with reference to the accompanying drawings. Throughout the drawings, the same drawing reference numerals will be understood to refer to the same elements, features and structures. In addition, detailed descriptions of well-known functions and constructions are omitted for clarity and conciseness.

A taxi passenger would be able use taxis more securely and conveniently, if information about a taxi driver (e.g., kindness level, assessment information generated by previous passengers, etc.) could be known before riding in the taxi. Therefore, in accordance with an embodiment of the present invention, a driver information server is proposed that stores driver information including identification information of taxi drivers and assessment information about the taxi drivers, and authentication information for the taxi drivers. The driver information server then provides the stored driver information to taxi passengers.

In addition, in accordance with an embodiment of the present invention, a management server is proposed that authenticates taxi drivers, searches for taxis near a taxi passenger, calls a taxi, searches for and tracks a taxi upon an emergency call by a taxi passenger, and updates assessment information about services provided by taxi drivers.

In accordance with an embodiment of the present invention, before driving a taxi, a taxi driver undergoes an authentication process for the taxi driver and the taxi by placing the taxi driver's mobile terminal on a terminal holder (or terminal cradle) mounted in the taxi.

Further, a taxi passenger can select a taxi, after receiving driver information of nearby empty taxis from the management server through the passenger's mobile terminal. Accordingly, and the passenger can check the received driver information before entering the taxi.

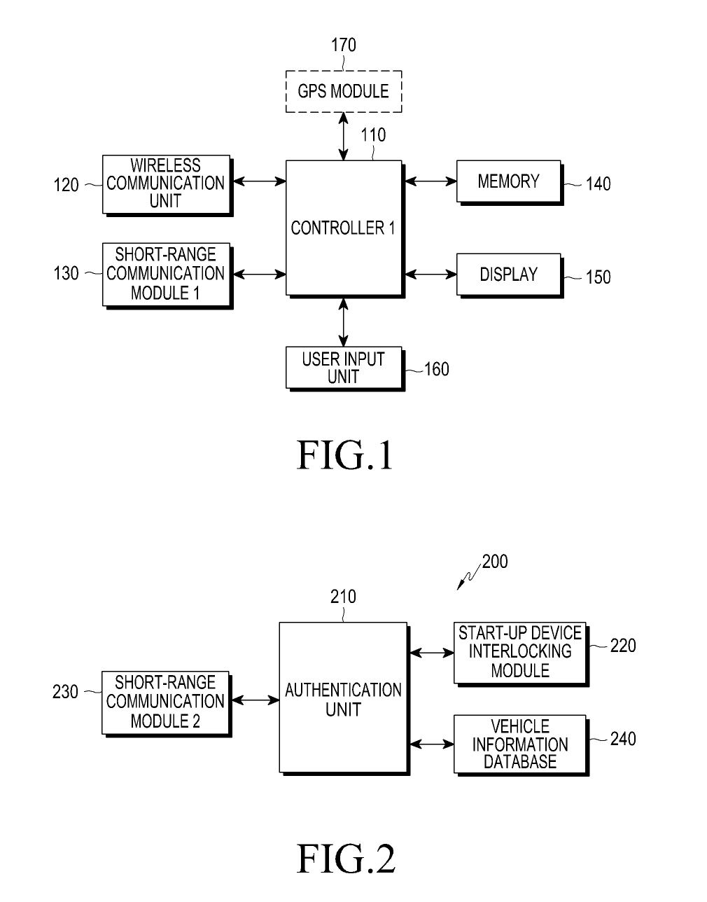

FIG. 1 is a block diagram illustrating a mobile terminal according to an embodiment of the present invention. Specifically, the mobile terminal structure illustrated in FIG. 1 may be applied to a taxi passenger's mobile terminal (hereinafter referred to as a “user terminal”), a taxi driver's mobile terminal (hereinafter referred to as a “driver terminal”), and a taxi guard mobile terminal (hereinafter referred to as a “guard terminal”), which are described in more detail below, and include mobile phone, a Personal Digital Assistant (PDA), a smart phone, a navigation terminal, etc.

Referring to FIG. 1, the mobile terminal includes a controller 110, a wireless communication unit 120, a short-range communication module 130, a memory 140, a display 150, and a user input unit 160. The mobile terminal may further include a Global Positioning System (GPS) module 170.

The user input unit 160 may include a keypad or a touch screen including function keys, alphanumeric keys and arrow keys, a touch pad, a microphone, etc. The display 150 may include a Liquid Crystal Display (LCD), a Light Emitting Diode (LED) display, an Active-Matrix Organic Light-Emitting Diode (AMOLED), etc.

The memory 140 stores processing and control programs for the first controller 110, reference data, various updatable archival data, phone numbers, etc., and serves as a working memory of the controller 110. Additionally, the memory 140 may store program data used to provide various functions to the mobile terminal. Further, the memory 140 may store various information received through the wireless communication unit 120 or the first short-range communication module 130.

The wireless communication unit 120 transmits and receives various data by performing mobile communication. The types of mobile communication supportable by the wireless communication unit 120 may include Global System for Mobile communications (GSM), Wideband Code Division Multiple Access (WCDMA), Long Term Evolution (LTE), Wireless Broadband (Wibro), etc.

The short-range communication module 130 performs short-range communication such as a Universal Serial Bus (USB), Bluetooth, Zigbee, Wireless-Fidelity (Wi-Fi), etc.

The controller 110 controls the overall operation of the mobile terminal, which includes controlling the above-described components of the mobile terminal. Specifically, the controller 110 generates various messages, and controls related components so that the generated messages may be sent in an appropriate manner. For example, the controller 110 processes various messages received through the wireless communication unit 120 or the short-range communication module 130, and stores information included in the messages in the memory 140 or displays the information on the display 150. The controller 110 sets a proper operation mode, and controls related components associated with the set operation mode.

For example, when the mobile terminal is a driver terminal, the controller 110 sets short-range communication between the driver terminal and a terminal holder by controlling the short-range communication module 130, and controls operations of the mobile terminal and its components for driver authentication. As will be described below, the controller 110 controls operations of the driver terminal and its components for a taxi search process, a taxi call process, and a taxi boarding and taxi boarding complete process.

When the mobile terminal is a user terminal, the controller 110 controls operations of the user terminal and its components for a taxi search process, a taxi call process, a taxi boarding and taxi boarding complete process, an emergency call process and a driver assessment process, which will also be described below.

Additionally, when the mobile terminal is a guard terminal, the controller 110 controls operations of the guard terminal and its components to track a specific user terminal, as will be described below in more detail.

FIG. 2 is a block diagram illustrating a terminal holder according to an embodiment of the present invention. Specifically, FIG. 2 illustrates a terminal holder 200, in which a mobile terminal is received. Accordingly, the terminal holder 200 is mounted in a taxi, and is designed such that a mobile terminal can be received therein.

Referring to FIG. 2, the terminal holder 200 includes an authentication unit 210, a start-up device interlocking module 220, a short-range communication module 230, and a vehicle information database 240.

The short-range communication module 230 performs short-range communication such as USB connection, Bluetooth, Zigbee, Wi-Fi, etc.

The vehicle information database 240 stores a vehicle number of the taxi in which the terminal holder 200 is mounted. Additionally, the vehicle information database 240 may store information about the taxi and information about drivers who have driven the taxi before.

The start-up device interlocking module 220 allows the driver to start up an engine of the vehicle or taxi, under control of the authentication unit 210. Optionally, the start-up device interlocking module 220 may stop the engine, when the mobile terminal is detached or picked up from the terminal holder 200.

After short-range communication is connected to the mobile terminal received in the terminal holder 200, the authentication unit 210 transmits the vehicle number stored in the vehicle information database 240 to the mobile terminal through the short-range communication module 230, upon an authentication request received from the mobile terminal through the short-range communication module 230. Upon receiving an authentication success message from the mobile terminal received in the mobile holder 200 through the short-range communication module 230, the authentication unit 210 controls the start-up device interlocking module 220 to start up the engine of the taxi. Additionally, the authentication unit 210 may acquire fare information from the taxi and transmit the fare information to the user terminal.

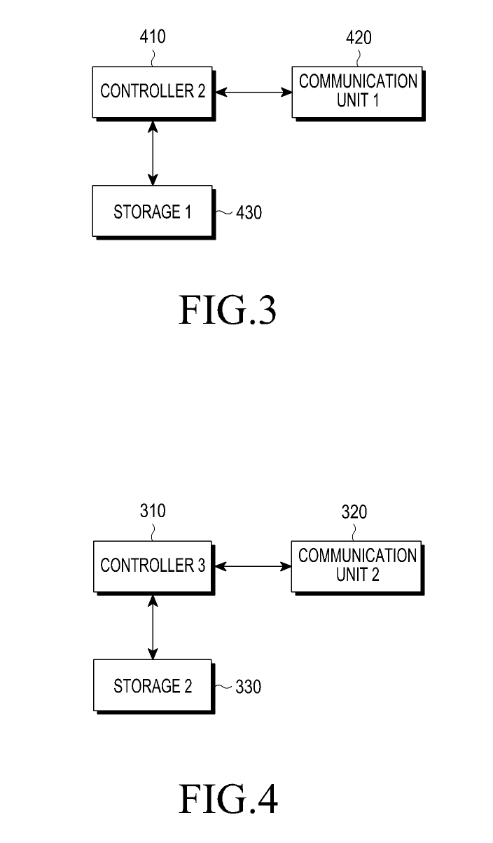

FIG. 3 is a block diagram illustrating a management server according to an embodiment of the present invention.

A management server is a server device that provides information about taxis and taxi drivers to user terminals. In accordance with an embodiment of the present invention, upon receiving a taxi search request from a user terminal, the management server searches for taxis nearby the user terminal, collects information about drivers of the located taxis, and transmits the information to the user terminal. Upon receiving a taxi call request from a user terminal, the management server forwards the call request to a selected taxi, and transmits availability and location information of the taxi to the user terminal. Upon receiving an emergency call request from a user terminal, the management server enables a guard terminal to track the location of the user terminal. Further, the management server stores and updates assessment information about services provided by taxi drivers, received from user terminals.

Referring to FIG. 4, the management server includes a controller 410, a communication unit 420, and a storage 430, i.e., a memory.

The communication unit 420 communicates with mobile terminals and a driver information server. The storage 430 stores processes and control programs for the controller 410, reference data, various updatable archival data, etc., and serves as a working memory of the controller 410.

In accordance with an embodiment of the present invention, the storage 430 stores a recommended taxi driver list, a taxi tracking list, and detailed driver assessment information. Additionally, the storage 430 may store driver information. In addition, the storage 430 may store information received from the mobile terminals or the driver information server.

The controller 410 controls the overall operation of the management server, and controls various operations of the management server.

To provide a safe taxi service, in accordance with an embodiment of the present invention, a driver information server is provided that stores taxi vehicle information and information about taxi drivers. Specifically, the driver information server is a server device that stores authentication information and driver information for taxi drivers, and provides the stored driver information or performs driver authentication upon request. The driver information includes information about taxi drivers, taxi numbers, taxi vehicle numbers, taxi driver phone numbers, driver assessments, etc.

FIG. 4 is a block diagram illustrating a driver information server according to an embodiment of the present invention.

Referring to FIG. 4, the driver information server includes a controller 310, a communication unit 320, and a storage 330, i.e., memory.

The communication unit 320 communicates with mobile terminals and the management server. The storage 330 stores processing and control programs for the controller 310, reference data, various updatable archival data, etc., and serves as a working memory of the controller 310.

In accordance with an embodiment of the present invention, the storage 330 stores authentication information and driver information.

The controller 310 controls the overall operation of the driver information server, and controls various operations of the driver information server.

The driver information server may be managed by a nationally accredited organization for managing taxis, or by a taxi operators association, and may be included in a management server.

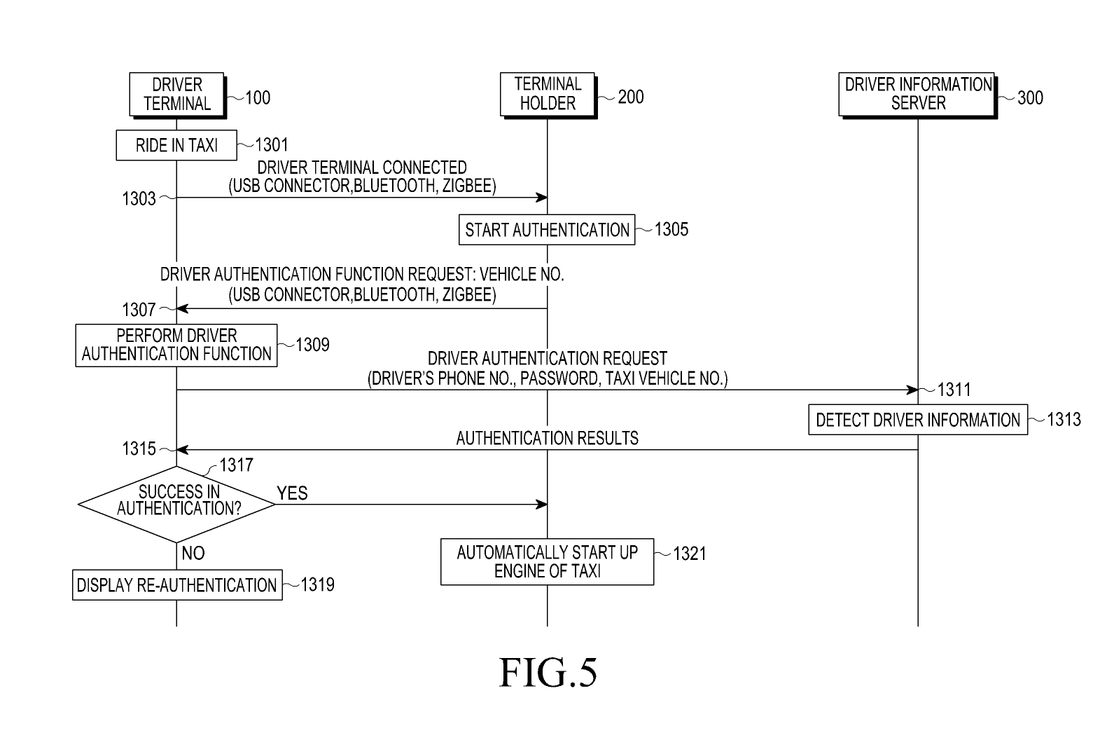

FIG. 5 is a signal flow diagram illustrating taxi driver authentication and driving preparation processes according to an embodiment of the present invention.

Referring to FIG. 5, in step 1301, upon entering a taxi, a taxi driver puts an associated mobile terminal, i.e., a driver terminal 100, on a terminal holder 200 mounted in the taxi. The terminal holder 200 stores vehicle number information of the taxi, and may not be used in other taxis.

When the driver terminal 100 is connected to the terminal holder 200 through short-range communication such as USB connection, Bluetooth, Zigbee, etc., in step 1303, the driver terminal 100 authenticates taxi driver to the taxi by sending a driver authentication start message to the terminal holder 200 through the connected short-range communication in step 1305.

Upon receiving the driver authentication start message, the terminal holder 200 sends a driver authentication function request message including a vehicle number of the taxi to the driver terminal 100 in step 1307.

Upon receiving the driver authentication function request message, the driver terminal 100 displays an authentication screen on its display, in which the taxi driver inputs a password for authentication, and selects a displayed authentication menu.

In step 1309, the driver terminal 100 generates a driver authentication request message including the password input from the driver, the vehicle number received from the terminal holder 200, and the phone number of the driver terminal 100.

In step 1311, the driver terminal 100 sends the driver authentication request message to a driver information server 300. For example, the driver authentication request message may be sent to the driver information server 300 through a mobile communication network or Wi-Fi.

In step 1313, upon receiving the driver authentication request message, the driver information server 300 detects driver information, and performs authentication on the driver by determining whether the driver information server 300 has information identical to the information included in the driver authentication request message. In step 1315, the driver information server 300 sends an authentication result message, which includes the authentication results, to the driver terminal 100.

In step 1317, the driver terminal 100 determines whether the authentication is successful based on the authentication results included in the received authentication result message. If the authentication is successful, the driver terminal 100 sends an authentication success message to the terminal holder 200, enabling the taxi to start its engine in step 1321. The taxi engine may automatically start, upon receipt of the authentication success message, or receipt the authentication success message may unlock the ignition, enabling the taxi driver to start the taxi.

When the authentication results included in the received authentication result message indicate a failed authentication, the driver terminal 100 displays a re-authentication screen for the driver in step 1319.

Optionally, if the driver detaches the driver terminal 100 from the terminal holder 200, the terminal holder 200 may be configured to automatically stop the engine of the taxi.

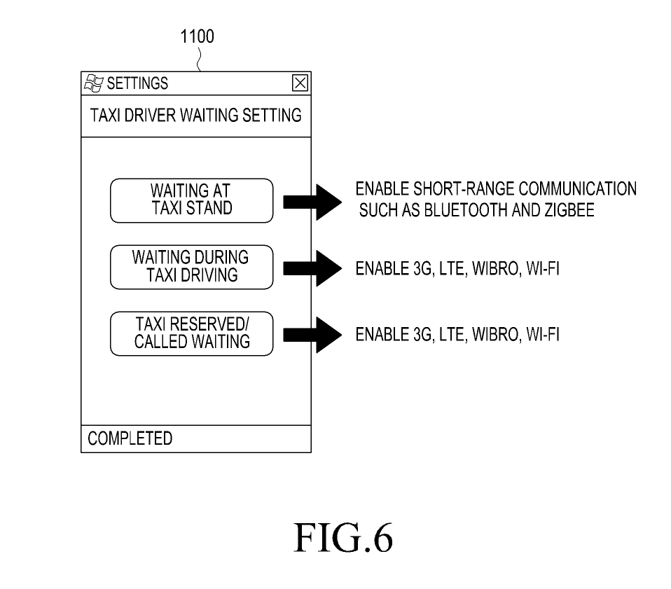

FIG. 6 illustrates a waiting state selection screen of a user terminal according to an embodiment of the present invention.

Referring to FIG. 6, upon completing the authentication process illustrated in FIG. 5, the driver terminal 100 sets a waiting mode, and displays a waiting state selection screen 1100.

In accordance with an embodiment of the present invention, the waiting state includes three different states (or modes): a waiting-at-taxi-stand state indicating that the driver is waiting for a passenger at a taxi stand, a waiting-during-taxi-driving state indicating that the driver is driving the taxi to find a passenger, and a taxi-reserved/called waiting state indicating that the driver is going to pick up the passenger who already reserved/called the taxi.

By displaying the waiting state selection screen 1100, the driver terminal 100 guides the taxi driver to select a proper waiting state, thereby making it possible to set the corresponding waiting mode. Alternatively, the driver terminal 100 may automatically set a related waiting mode depending on the surrounding environment.

For example, the waiting-at-taxi-stand state indicates that the driver is waiting for taxi passengers at a taxi stand, with the taxi stopped. When the driver selects “Waiting at Taxi Stand”, the driver terminal 100 sets the waiting-at-taxi-stand mode, activates a short-range communication module, and maintains the active state of mobile communication to receive a taxi reservation/call request.

In an alternative embodiment, more intelligently, the driver terminal 100 may recognize a taxi stand using the short-range communication function and automatically set the waiting-at-taxi-stand mode when the taxi is parked by the taxi stand for a predetermined time. For example, a terminal installed at the taxi stand periodically broadcasts a taxi stand notification message, and the driver terminal 100 sets the waiting-at-taxi-stand mode when it has received the taxi stand notification message for a predetermined time.

The waiting-during-taxi-driving state that the driver is driving the empty taxi to find a passenger. When the taxi driver selects “Waiting during Taxi Driving”, the driver terminal 100 sets the waiting-during-taxi-driving mode, and maintains the active state of mobile communication or Wi-Fi, enabling a user terminal (or passenger) to search for the taxi, and making it possible to respond to a call from the user terminal.

The taxi-reserved/called waiting state indicates that the taxi is called or reserved by a passenger. When the taxi driver selects “Taxi Reserved/Called Waiting”, the driver terminal 100 sets the taxi-reserved/called waiting mode, and maintains the active state of mobile communication or Wi-Fi, making it possible to detect the location of the user terminal (or passenger). For example, the driver terminal 100 may receive location information from the passenger's user terminal through mobile communication or Wi-Fi.

In accordance with an embodiment of the present invention, the taxi search by a passenger is divided into three different methods: a nearby taxi search, a faraway taxi search, and a recommended taxi search.

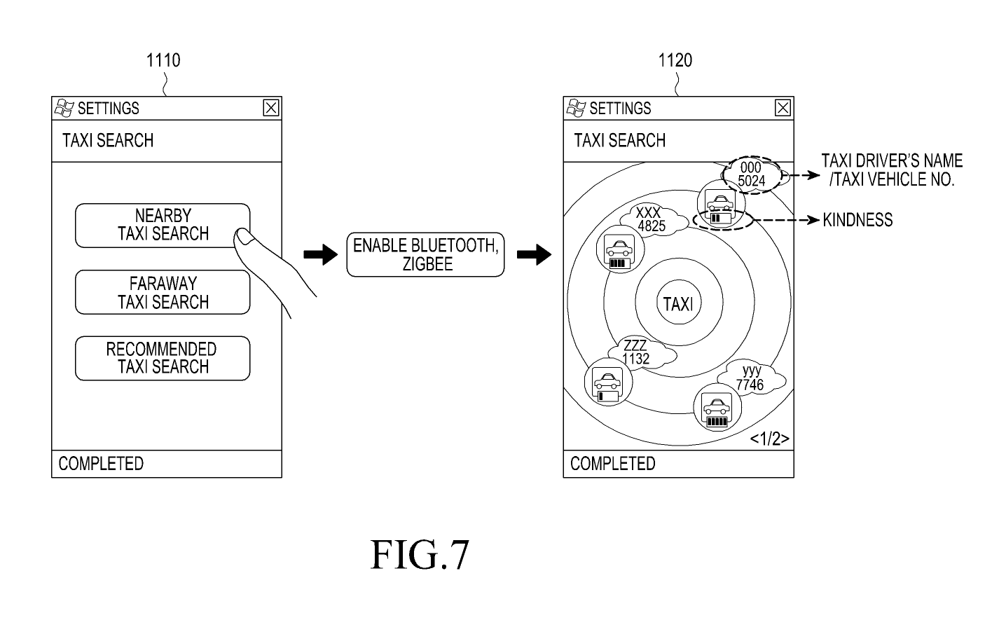

FIG. 7 illustrates nearby taxi search screens according to an embodiment of the present invention.

Referring to FIG. 7, a passenger (hereinafter referred to as a “taxi user”) desiring to ride in a taxi may use their mobile terminal, i.e., user terminal, to search for nearby taxis and/or their driver information. Accordingly, if the taxi user selects a taxi search menu on the user terminal, the user terminal displays a nearby taxi search screen 1110.

When the taxi user wants to search for taxis waiting at a taxi stand, the taxi user selects “Nearby Taxi Search” in the Taxi Search menu on the user terminal. During the nearby taxi search, the user terminal searches for taxis using the short-range communication function. This assumes that a driver terminal 100 in a taxi waiting at the taxi stand has set the waiting-at-taxi-stand mode.

After the nearby taxi search, the user terminal 500 displays the search results on a nearby search result screen 1120, which includes a vehicle number of each taxi, a name of its driver, kindness level information of the driver, etc. The taxi user may see a taxi driver personal assessment board in a sub menu. In accordance with an embodiment of the present invention, the kindness level is a numerical assessment that taxi users have made for the taxi driver after riding in the taxi, and the personal assessment board has detailed assessments about the taxi driver.

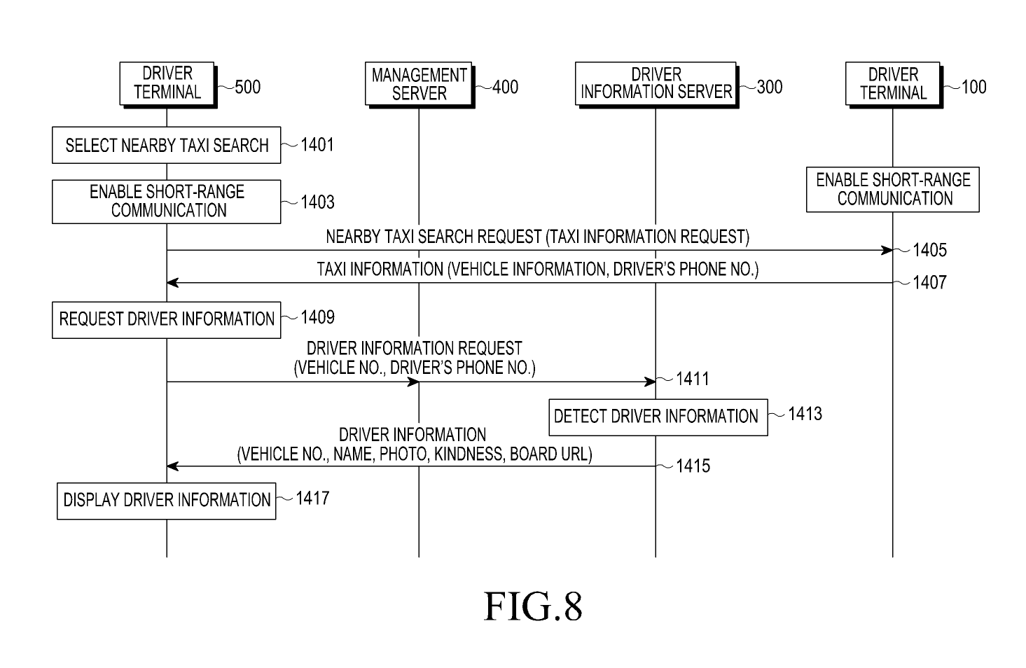

FIG. 8 is a signal flow diagram illustrating a nearby taxi search process according to an embodiment of the present invention.

Referring to FIG. 8, when nearby taxi search is selected in step 1401, the taxi user, i.e., a user terminal 500, enables a short-range communication module in step 1403. In step 1405, the user terminal 500 broadcasts a nearby taxi search request message including a taxi information request by short-range communication.

A driver terminal 100 having set the waiting-at-taxi-stand mode receives the nearby taxi search request message, and sends a taxi information message in response thereto by short-range communication in step 1407. The taxi information message includes a vehicle number of the taxi and a phone number of the driver terminal 100. The taxi information message may be sent by either the driver terminal 100 or the terminal holder 200. For example, the phone number of the driver terminal 100 may be acquired from the driver terminal 100, and the vehicle number may be acquired from the terminal holder 200.

Upon receiving the taxi information message, the user terminal 500 generates a driver information request message including the phone number of the driver terminal 100 and the vehicle number, as included in the taxi information message, in step 1409.

Although FIG. 8 illustrates only one driver terminal 100, the driver information request message may include information about multiple driver terminals 100 and their associated taxis.

In step 1411, the user terminal 500 sends the driver information request message to a management server 400 using mobile communication, and the management server 400 stores the received driver information request message and then sends the driver information request message to the driver information server 300.

In step 1413, upon receiving the driver information request message, the driver information server 300 detects related taxi driver information based on the phone number of the driver terminal 100 and the vehicle number included in the driver information request message. For example, driver information may include a vehicle number of the taxi, name of the taxi driver, driver assessment information, a photo of the taxi driver, etc. The driver assessment information, i.e., taxi user comments about the driver's previous service, may include a kindness level and detailed information address. As described above, the kindness level is a numerical assessment that previous taxi passengers have made for the taxi deriver's service, and the detailed information address may be Uniform Resource Locator (URL) information of a posting board where detailed assessments of the taxi driver are posted. The detailed information about the driver may be located in the management server 400 and/or the driver information server 300.

In step 1415, the driver information server 300 sends a driver information message including the detected driver information to the management server 400, and the management server 400 forwards the received driver information message to the user terminal 500.

In step 1417, upon receiving the driver information message, the user terminal 500 displays information representing a vehicle number of the taxi, a name of the taxi driver, and a kindness level of the taxi driver, e.g., as illustrated in the nearby search result screen 1120 of FIG. 7.

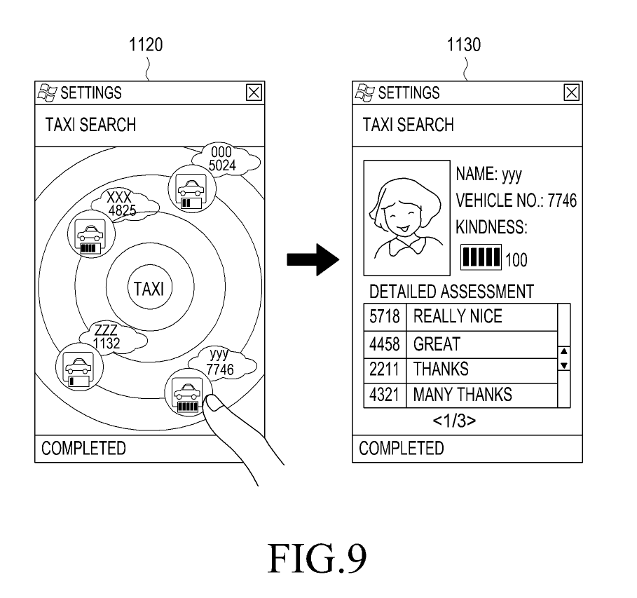

FIG. 9 illustrates detailed taxi information screens according to an embodiment of the present invention. Specifically, FIG. 9 illustrates a detailed search screen 1130 about the driver, which is displayed as the user selects a taxi on the nearby search result screen 1120.

Referring to FIG. 9, upon receiving a detailed driver information request input from the user, a user terminal accesses a related URL address based on a detailed information address included in a driver information message, and displays the detailed assessment information for the driver, as illustrated in the detailed search screen 1130.

A taxi user may select any of the taxis displayed on the nearby search result screen 1120 and take a ride in the selected taxi.

After riding in the taxi, the taxi user inputs a “Boarding Complete” input for the taxi. In response to the boarding complete input from the taxi user, a user terminal sets a taxi boarding mode, and stores a phone number of a driver terminal and a vehicle number of the taxi in a memory as boarding taxi information (information about the taxi the taxi user has ridden in). For example, the user terminal can send a taxi boarding complete request message to the driver terminal using short-range communication, and the taxi boarding complete request message may include a phone number of the user terminal, a vehicle number of the taxi, a phone number of the driver terminal, etc.

Upon receiving the taxi boarding complete request message in the waiting-at-taxi-stand mode through short-range communication, a driver terminal compares the phone number of the driver terminal included in the received taxi boarding complete request message, with its own phone number. If the phone numbers are identical, the driver terminal inactivates the waiting-at-taxi-stand mode, and stores the phone number of the user terminal included in the taxi boarding complete request message, as boarding passenger information. Thereafter, the driver terminal may set a boarding driving mode, and maintain the active state of mobile communication or Wi-Fi.

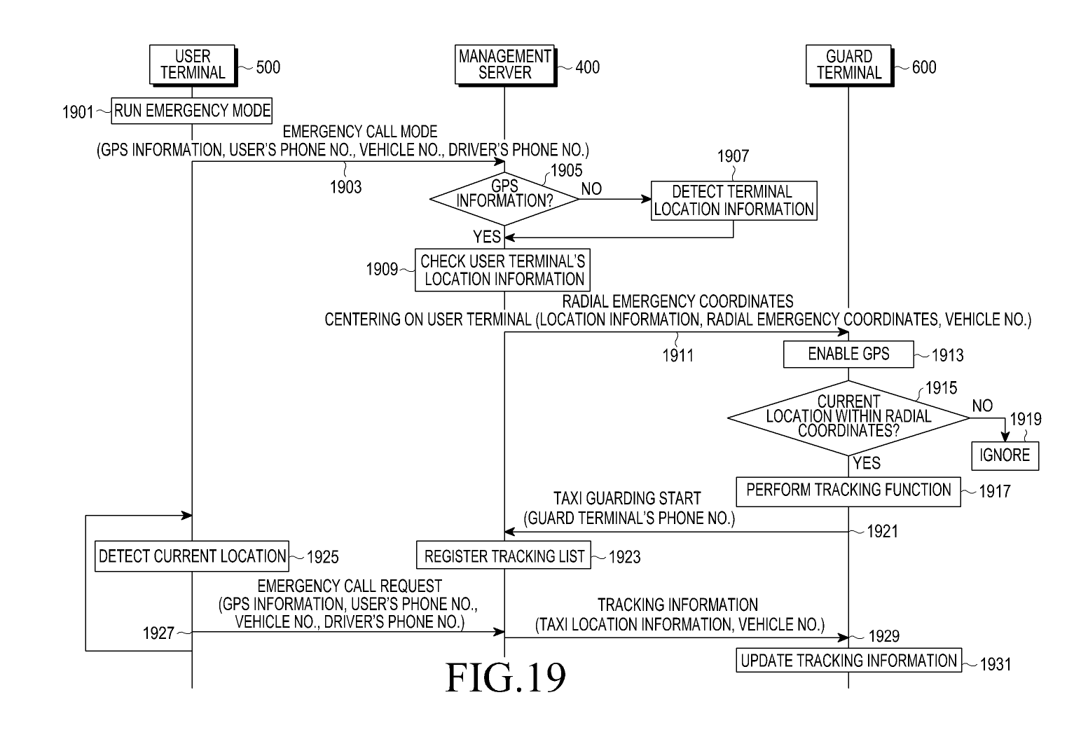

After setting the taxi boarding mode, the user terminal can still monitor for an emergency call request. An emergency call request enables a taxi user to ask for help in case of an emergency during a taxi ride. An emergency call request process will be described in more detail below with reference to FIG. 19.

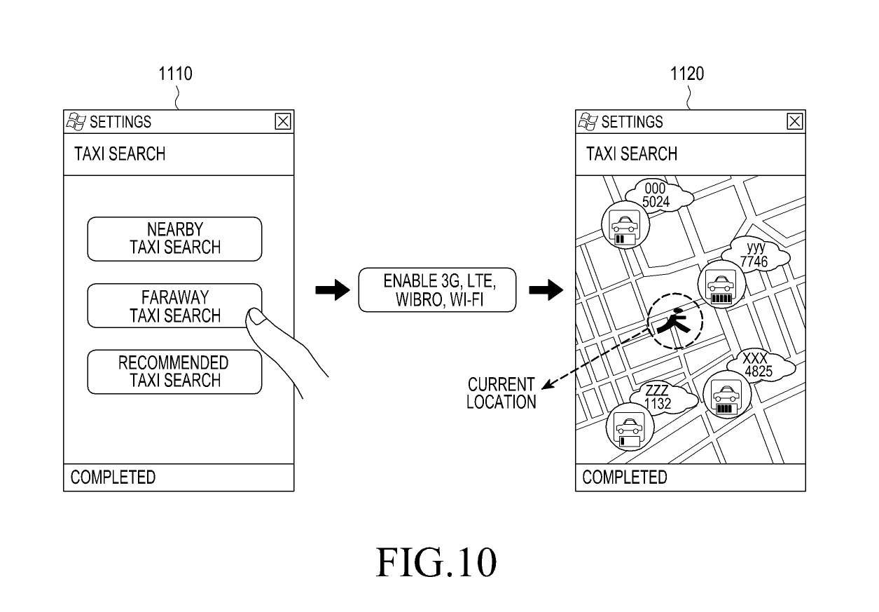

FIG. 10 illustrates faraway taxi search screens according to an embodiment of the present invention.

A taxi user selects a faraway taxi search menu in the taxi search menu on a user terminal when the taxi user wants to search for an empty taxi. For the faraway taxi search, taxis are searched for using mobile communication, for example, GSM, WCDMA, LTE, Wibro, Wi-Fi, etc. The search results of the faraway taxi search may be provided as, for example, as illustrated in a faraway search result screen 1140.

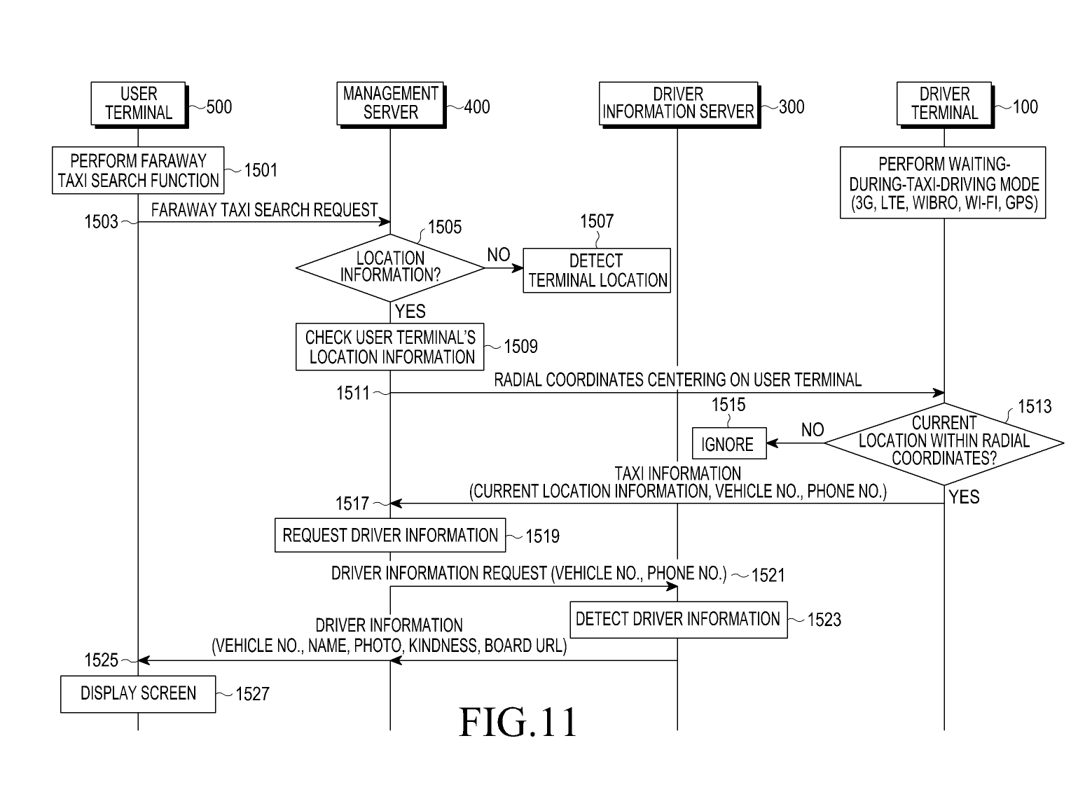

FIG. 11 is a signal flow diagram illustrating a faraway taxi search process according to an embodiment of the present invention.

Referring to FIG. 11, upon receiving a faraway taxi search request input from a taxi user, in step 1501, a user terminal 500 starts a faraway taxi search function. If the user terminal 500 includes a GPS module, the user terminal 500 may enable the GPS module in step 1501.

In step 1503, the user terminal 500 generates a faraway taxi search request message and sends it to a management server 400. The faraway taxi search request message may include location information of the user terminal 500, e.g., location information acquired by the GPS module.

Upon receiving the faraway taxi search request message, in step 1505, the management server 400 determines whether the faraway taxi search request message includes location information. If location information is included in the faraway taxi search request message, in step 1509, the management server 400 calculates radial coordinates based on the location information. However, if no location information is included in the faraway taxi search request message, the management server 400 determines approximate location information of the user terminal 500 based on cell information of the user terminal 500 in the mobile communication network in step 1507, and then calculates radial coordinates in step 1509.

In step 1511, the management server 400 sends a taxi search request message including the radial coordinates to a driver terminal 100. Information about the driver terminal 100, may be stored in the management server 400, as the driver terminal 100 reports it to the management server 400 when setting its operation mode.

Upon receiving the taxi search request message, in step 1513, the driver terminal 100 determines whether its current location falls within the radial coordinates included in the taxi search request message. When the current location of the driver terminal 100 does not fall within the radial coordinates, the driver terminal 100 ignores the reception of the taxi search request message in step 1515. However, when the current location of the driver terminal 100 falls within the radial coordinates, the driver terminal 100 generates a taxi information message including the current location information of the driver terminal 100, the taxi vehicle number, and the phone number of the driver terminal 100, and sends it to the management server 400 in step 1517.

Upon receiving the taxi information message, the management server 400 generates a driver information request message including the taxi vehicle number and the phone number of the driver terminal 100 in step 1519, and sends the generated driver information request message to the driver information server 300 in step 1521.

Upon receiving the driver information request message, the driver information server 300 detects driver information based on the phone number of the driver terminal 100 and the taxi vehicle number in step 1523. As described above, the detected driver information may include a vehicle number of the taxi, a name of the taxi driver, assessment information of the taxi driver, a photo of the taxi driver, etc., and the driver assessment information may include a kindness level and detailed information address.

In step 1525, the driver information server 300 sends a driver information message including the detected driver information to the management server 400, and the management server 400 forwards the received driver information message to the user terminal 500. If the location information of the driver terminal 100 is not included in the faraway taxi search request message received in step 1503, the management server 400 may add in the driver information message the current location information of the driver terminal 100, detected in step 1507.

Upon receiving the driver information message, the user terminal 500 displays its current location and the locations of the searched taxis on the map based on the location information of the driver terminal 100 included in the driver information message, and displays the vehicle number of the taxi, the name of the taxi driver, and the kindness level of the taxi driver, as illustrated in the faraway taxi search result screen 1140 of FIG. 9, in step 1527.

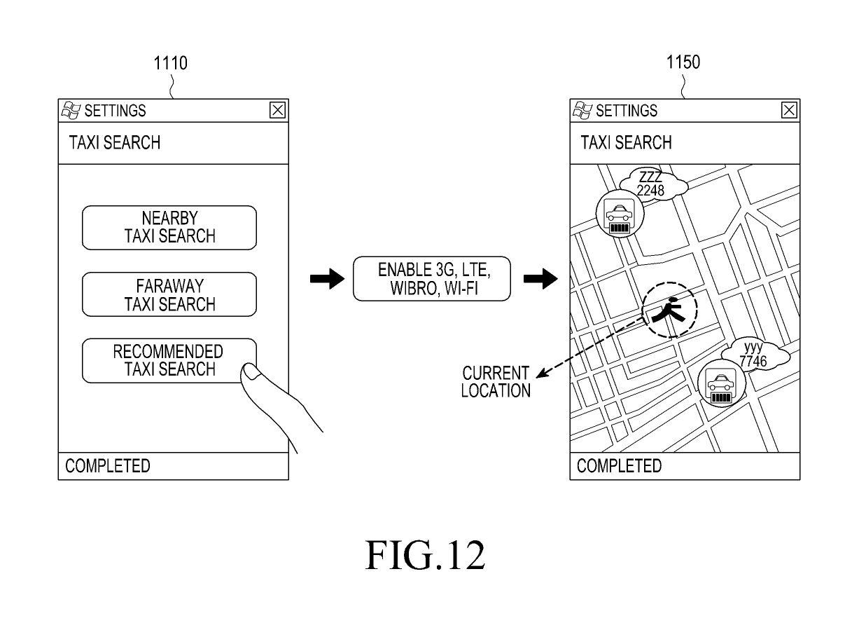

FIG. 12 illustrates recommended taxi search screens according to an embodiment of the present invention.

A user terminal may store its own recommended taxi driver list, or share a recommended taxi driver list of another user. The recommended taxi driver list may be acquired from a management server. The results of the recommended taxi search may be displayed as shown in a recommended taxi search result screen 1150.

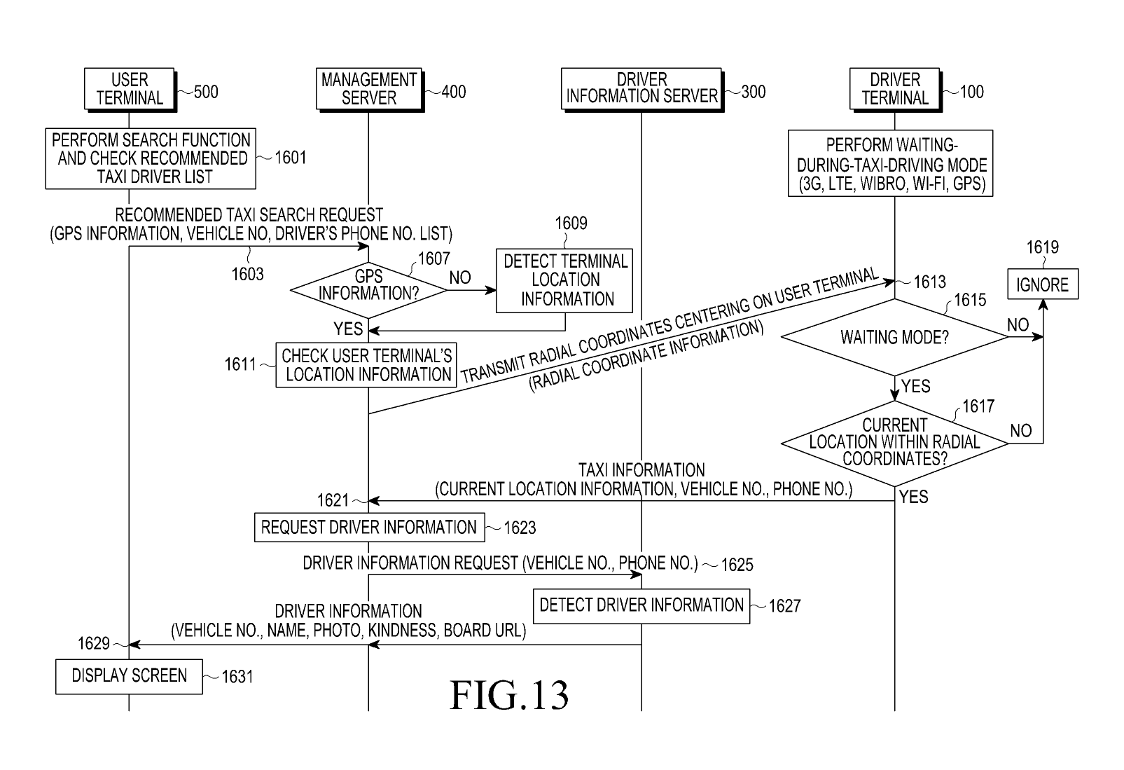

FIG. 13 is a signal flow diagram illustrating a recommended taxi search process according to an embodiment of the present invention.

Referring to FIG. 13, in step 1601, upon receiving a recommended taxi search request from a taxi user, a user terminal 500 starts a recommended taxi search function and maintains the active state of mobile communication or Wi-Fi. The user terminal 500 may enable a GPS module. The user terminal 500 checks a recommended taxi driver list stored in a memory. The recommended taxi driver list may be acquired from the management server 400 and stored in the user terminal 500, or may be acquired from another user terminal and stored in the user terminal 500.

In step 1603, the user terminal 500 generates a recommended taxi search request message, possibly including GPS information, and a recommended taxi driver list (taxi vehicle number list and taxi driver phone number list), and sends it to the management server 400.

Upon receiving the recommended taxi search request message, the management server 400 determines in step 1607 whether the recommended taxi search request message includes location information of the driver terminal 100. If the location information, e.g., GPS information, is included, the management server 400 calculates radial coordinates determined based on the location information in step 1611. However, if the location information is not included, the management server 400 determines approximate location information based on cell information of the user terminal 500 in the mobile communication network in step 1609, and calculates radial coordinates in step 1611.

In step 1613, the management server 400 generates a taxi search request message including the radial coordinates, and sends the taxi search request message to a driver terminal 100 of a taxi driver included in the recommended taxi driver list. For example, an Internet Protocol (IP) address or a phone number of the driver terminal 100 may be used as a destination address.

Upon receiving the taxi search request message, in step 1615, the driver terminal 100 determines whether its current operation mode is the waiting-during-taxi-driving mode or the waiting-at-taxi stand mode. If the current operation mode is in the waiting-during-taxi-driving mode or the waiting-at-taxi stand mode, the driver terminal 100 determines whether its current location information falls within the received radial coordinates in step 1617. When the current operation mode is not in the waiting-during-taxi-driving mode or the waiting-at-taxi stand mode in step 1615 or when the current location does not fall within the radial coordinates in step 1617, the driver terminal 100 ignores the reception of the taxi search request message in step 1619. However, when the current location falls within the radial coordinates in step 1617, the driver terminal 100 generates a taxi information message including the current location information, the taxi vehicle number, and the phone number of the driver terminal 100, and sends it to the management server 400 in step 1621.

Upon receiving the taxi information message, the management server 400 generates a driver information request message including the taxi vehicle number and the phone number of the driver terminal 100 in step 1623, and sends the generated driver information request message to the driver information server 300 in step 1625.

Upon receiving the driver information request message, the driver information server 300 detects driver information based on the phone number of the driver terminal 100 and the taxi vehicle number in step 1627. The detected driver information may include a vehicle number of the taxi, a name of the taxi driver, and assessment information of the taxi driver, and may further include a photo, which is a photo of the taxi driver. The driver assessment information may include a kindness level and detailed information address. The kindness level is a numerical assessment that previous taxi passengers have made for the taxi deriver's service, and the detailed information address is URL information of the board where the detailed assessment of the taxi driver is posted.

In step 1629, the driver information server 300 sends a driver information message including the detected driver information to the management server 400, and the management server 400 includes the current location information of the driver terminal 100 in the received driver information message and sends it to the user terminal 500.

Upon receiving the driver information message, the user terminal 500 displays its current location and the locations of the searched taxis on the map based on the current location information of the taxi, and displays the vehicle number of the taxi, the name of the taxi driver, and the kindness level of the taxi driver on the recommended taxi search result screen 1150 in step 1631.

Alternatively, the user terminal 500 may perform a scheduler-linked taxi service, in which the user terminal 500 performs a taxi search function according to a specific schedule registered in a scheduler.

For example, if a schedule of appointment time and place is registered in a scheduler of the user terminal 500, the user terminal 500 requests path information between the current location and the appointment place from the management server 400 at a predetermined time. In response, the management server 400 derives the requested path information and transmits it to the user terminal 500. The path information may include an average driving time between the current location and the appointment place by taxi.

Based on the average driving time in the acquired path information, the user terminal 500 determines a reminder time, and displays a message asking the taxi user whether the taxi user will use (or ride in) a taxi, if the current time is the reminder time.

Upon receiving an input to use a taxi, the user terminal 500 searches for a taxi according to a process selected by the taxi user in the taxi search process, and provides the results to the taxi user.

The reminder time may be determined using Equation (1) below.

Reminder Time=(Appointment Time)−(Average Driving Time)−α. (1)

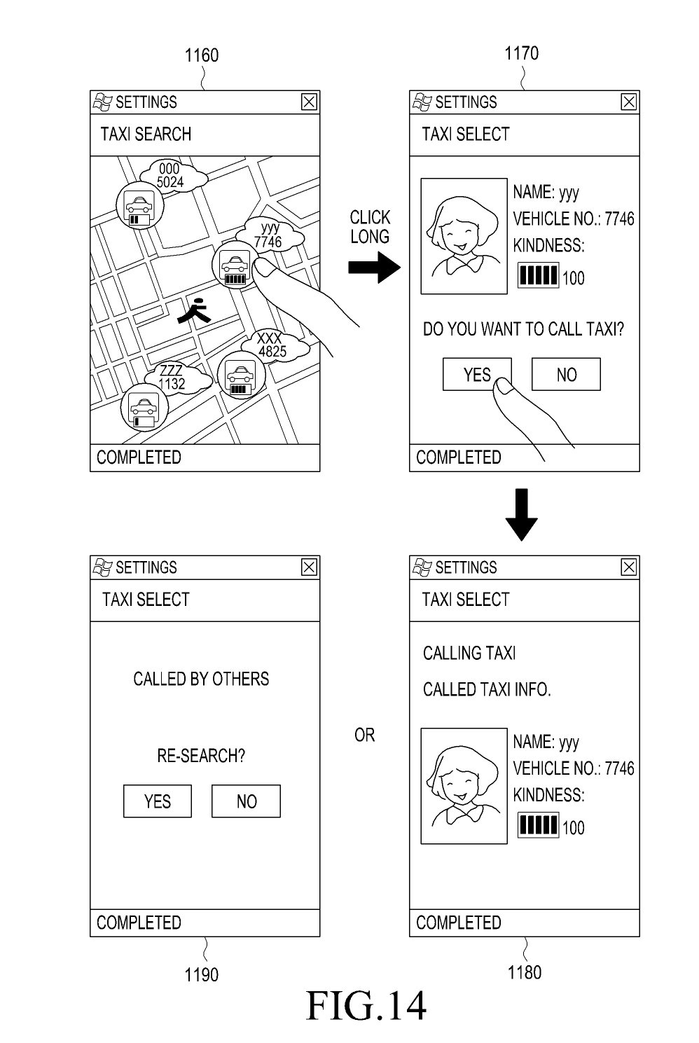

FIG. 14 illustrates a taxi selection/call screens according to an embodiment of the present invention.

Referring to FIG. 14, a taxi user may select a specific taxi icon displayed on a taxi search result screen 1160 of a user terminal, and the user terminal displays a taxi call screen 1170 upon receiving a selection input from the taxi user. For example, the taxi search result screen 1160 may be a faraway taxi search result screen or a recommended taxi search result screen. The taxi user may select and input “Call”, and in response, the user terminal re-checks the waiting state of the selected taxi, and informs the taxi user of the call results.

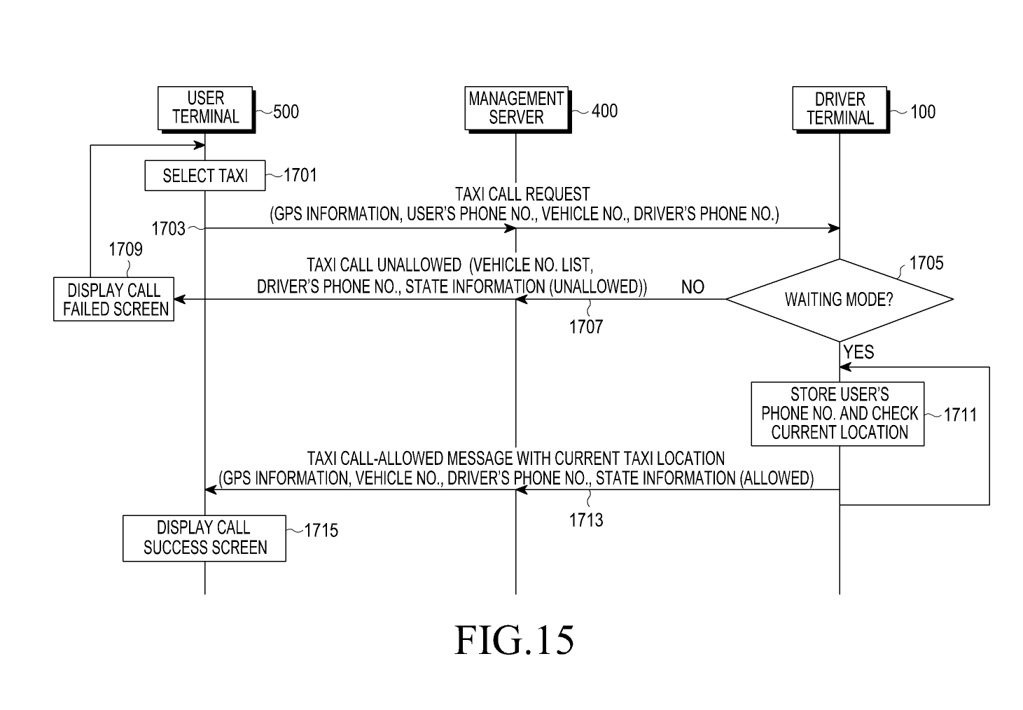

FIG. 15 is a signal flow diagram illustrating a taxi call process according to an embodiment of the present invention.

Referring to FIG. 15, in step 1701, a user terminal 500 receives an input to select and call a taxi from the taxi user, with a taxi search result screen displayed. In step 1703, the user terminal 500 sends a taxi call request message to a driver terminal 100 through a management server 400. The taxi call request message may include a phone number of the user terminal 500, a vehicle number of the taxi, a phone number of the driver terminal 100, and location information of the user terminal 500.

Upon receiving the taxi call request message, in step 1705, the driver terminal 100 determines whether the driver terminal 100 is now in the waiting-during-taxi-driving mode or the waiting-at-taxi stand mode. When the waiting-during-taxi-driving mode or the waiting-at-taxi stand mode is not set, the driver terminal 100 generates a taxi call-unallowed message and sends it to the user terminal 500 through the management server 400 in step 1707.

Upon receiving the taxi call-unallowed message, in step 1709, the user terminal 500 displays a message asking the taxi user to re-search for the same taxi, or a message asking the taxi user whether to search for another taxi, as illustrated in a call-failed screen 1190 of FIG. 14.

When the waiting-during-taxi-driving mode or the waiting-at-taxi stand mode is set, in step 1711, the driver terminal 100 displays the location information of the user terminal 500 included in the received taxi call request message, and stores the phone number of the user terminal 500 in a memory thereof as boarding passenger information. The boarding passenger information is used to identify passengers and manage a list of patrons of the driver terminal 100 upon a taxi user's ride.

In step 1713, the driver terminal 100 sends a taxi call-allowed message indicating a taxi call-allowed state to the user terminal 500 through the management server 400. The taxi call-allowed message includes the current location of the driver terminal 100 (i.e., the current location of the taxi vehicle), the vehicle number, the phone number of the driver terminal 100, and state information indicating the taxi call-allowed state. Thereafter, the driver terminal 100 sets the taxi-reserved/called waiting mode, and periodically sends the taxi call-allowed message until a user input indicating a taxi user's ride is received. The location information of the driver terminal 100 is periodically updated and included in the taxi call-allowed message.

In step 1715, upon receiving the taxi call-allowed message, the user terminal 500 displays a screen indicating the successful call, for example, a call success screen 1180 as illustrated in FIG. 14. The user terminal 500 receives the taxi call-allowed message that is periodically sent from the driver terminal 100, updates the location information of the driver terminal 100 using the received taxi call-allowed message, and displays the taxi call-allowed message.

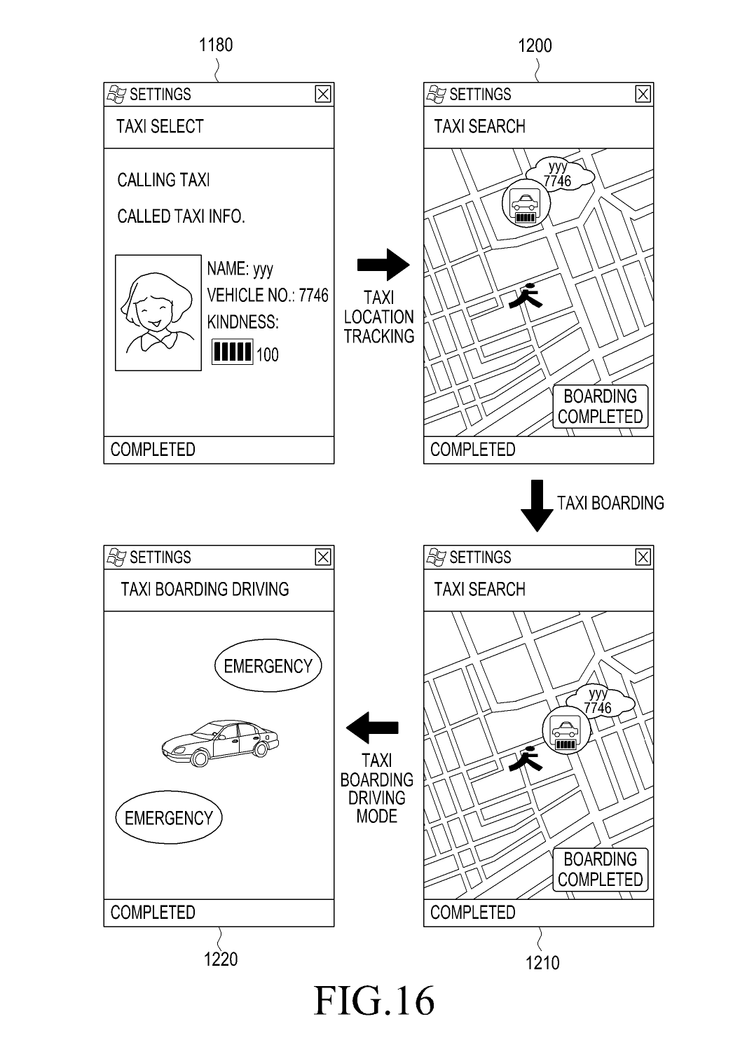

FIG. 16 illustrates screens for location tracking and boarding checking, after a taxi call, according to an embodiment of the present invention;

Referring to FIG. 16, a called taxi guidance screen 1200, making it possible to track the location of the taxi.

Upon entering the taxi of the driver terminal 100, a taxi user terminates the taxi call and selects “Boarding Complete”, as illustrated in screen 1210, to set a taxi boarding mode. In response, the user terminal 500 sets the taxi boarding mode, and displays a taxi boarding screen 1220.

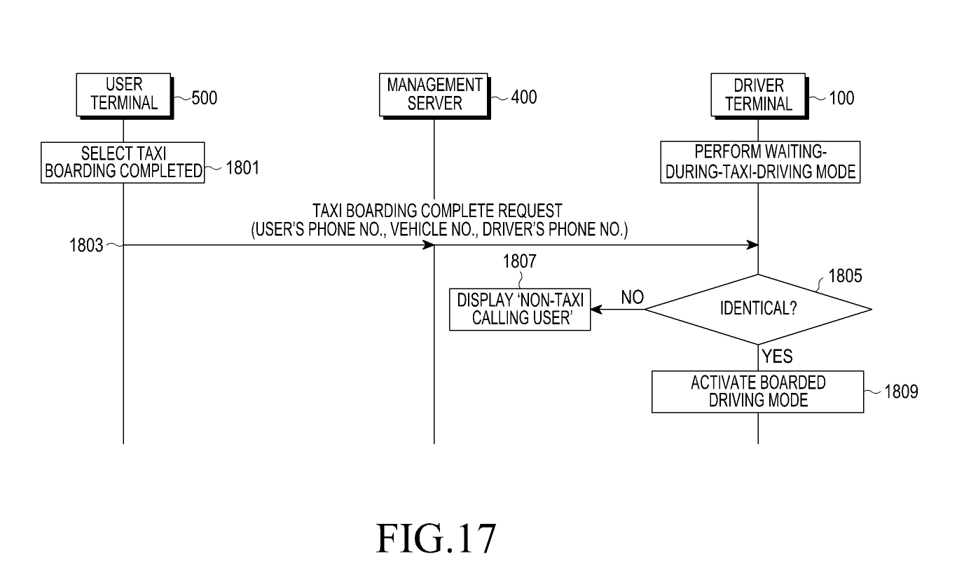

FIG. 17 is a signal flow diagram illustrating a taxi driving termination process according to an embodiment of the present invention.

Referring to FIG. 17, upon receiving a taxi boarding complete request from the taxi user in step 1801, a user terminal 500 sets a taxi boarding mode, generates a taxi boarding complete request message, and sends it to a driver terminal 100 through a management server 400 in step 1803. The taxi boarding complete request message includes a phone number of the user terminal 500, a vehicle number of the taxi, and a phone number of the driver terminal 100. Additionally, the user terminal 500 stores the vehicle number of the taxi and the phone number of the driver terminal 100 in its memory as boarding taxi information.

Upon receiving the taxi boarding complete request message, in step 1805, the driver terminal 100 determines whether the phone number of the user terminal 500 included in the taxi boarding complete request message is identical to the taxi user phone number stored in step 1711 of FIG. 15. When the phone numbers are not identical, the driver terminal 100 displays a “Non-Taxi Calling User” message in step 1807. However, when the phone numbers are identical, the driver terminal 100 activates a boarded driving mode in step 1809.

After setting the taxi boarded mode, the user terminal 500 can still monitor for an emergency call request. As described above, the emergency call request allows a taxi user to ask for help in case of an emergency during a taxi ride.

The emergency call request may be input by a user in various ways.

For example, in the taxi boarded mode, a specific key may be set as an emergency call key.

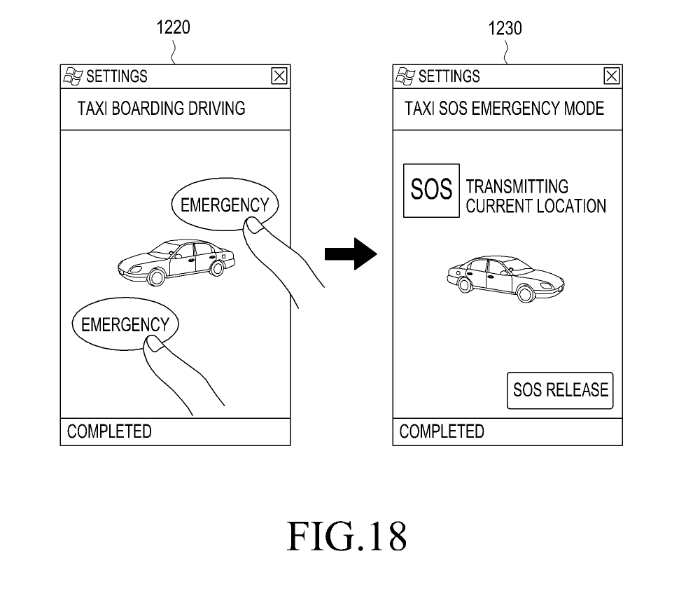

FIG. 18 illustrates emergency mode screens according to an embodiment of the present invention.

In accordance with an embodiment of the present invention, the taxi boarding screen 1220 may include an emergency button. It will be assumed herein that the taxi boarding screen 1220 includes two or more emergency buttons. Further, in order to prevent accidental pressing of the emergency buttons, positions of the two or more displayed emergency buttons are changed periodically, and an emergency call request is input when the two or more emergency buttons are simultaneously selected by the user.

FIG. 19 is a signal flow diagram illustrating a process of tracking a taxi in case of an emergency according to an embodiment of the present. Specifically, FIG. 19 illustrates a process of handling an emergency call request.

Referring to FIG. 19, upon occurrence of an emergency during the taxi ride, a taxi user simultaneously inputs (or touches) two emergency buttons displayed on the taxi boarding screen 1220, as illustrated in FIG. 18. In step 1901, the user terminal 500 sets an emergency mode. In the emergency mode, the user terminal 500 may display an emergency mode screen 1230.

In step 1903, based on the boarding taxi information stored in advance, the user terminal 500 generates an emergency call request message including identification information of the user terminal 500 and information about the taxi in which the taxi user has taken a ride, and sends it to a management server 400. The emergency call request message may include, for example, a phone number of the user terminal 500, a vehicle number of the boarding taxi, and a phone number of the driver terminal 100. The emergency call request message may include location information of the user terminal 500, e.g., GPS information.

Upon receiving the emergency call request message, in step 1905, the management server 400 determines whether the emergency call request message includes location information of the user terminal 500. If the location information is not included, the management server 400 detects location information of the user terminal 500 based on cell information of the user terminal 500 in cooperation with the mobile communication network in step 1907. If the detection of the location information is completed or if the emergency call request message includes the location information, the management server 400 checks the location information of the user terminal 500 and determines radial emergency coordinates having a radius centering on the location in step 1909.

In step 1911, the management server 400 generates an emergency call request message including the radial emergency coordinates and the location information of the user terminal 500, and sends it to a guard terminal 600. The emergency call request message may include the radial emergency coordinates, the location information of the user terminal 500, and the vehicle number of the taxi.

The guard terminal 600 tracks a taxi when an emergency occurs in the taxi, and may be used by, for example, police, hospitals, guard companies, other taxi vehicles, etc.

Upon receiving the emergency call request message, the guard terminal 600 enables a GPS module and detects its current location in step 1913, and determines in step 1915 whether its current location falls within the radial emergency coordinates.

When its current location does not fall within the radial emergency coordinates, the guard terminal 600 ignores the reception of the emergency call request message in step 1919. However, when its current location falls within the radial emergency coordinates, the guard terminal 600 displays the reception of the emergency call request message, and also displays a message asking whether to track the taxi, in step 1917. The guard terminal 600 may detect location information of the user terminal 500 from the emergency coordinates, and display it on the screen together. After checking the displayed information, a user of the guard terminal 600 may input (or touch) “Tracking Approval”, and in response, the guard terminal 600 may perform a taxi tracking function.

In step 1921, when a taxi tracking mode is set, the guard terminal 600 generates a taxi guarding start message including a phone number of the guard terminal 600, and sends it to the management server 400, making a proposal to participate in taxi guarding.

Upon receiving the taxi guarding start message, the management server 400 adds or registers the guard terminal 600 in a tracking list in step 1923. The tracking list includes information about the user terminal 500 having requested an emergency call, information about the guard terminal 600 having participated in guarding the user terminal 500, and location information of the user terminal 500.

After sending the emergency call request message in step 1903, the user terminal 500 detects its current location in real time in step 1925. In step 1927, the user terminal 500 periodically sends an emergency call request message including the detected current location to the management server 400. The user terminal 500 may periodically send the emergency call request message generated in step 1903, if the user terminal 500 has no GPS module.

The management server 400 detects location information of the user terminal 500 included in the emergency call request message or determines a location of the user terminal 500 when the location information of the user terminal 500 is not included. In step 1929, the management server 400 generates a tracking information message including the location information of the user terminal 500, and sends it to each guard terminal 600 having participated in guarding the user terminal 500, based on the tracking list. The tracking information message includes the location information of the user terminal 500 and the vehicle information of the taxi.

In step 1931, upon receiving the tracking information message, the guard terminal 600 displays the location of the user terminal 500 on its screen based on the location information of the user terminal 500, included in the tracking information message.

Accordingly, the user of the guard terminal 600 may track the taxi including the user terminal 500.

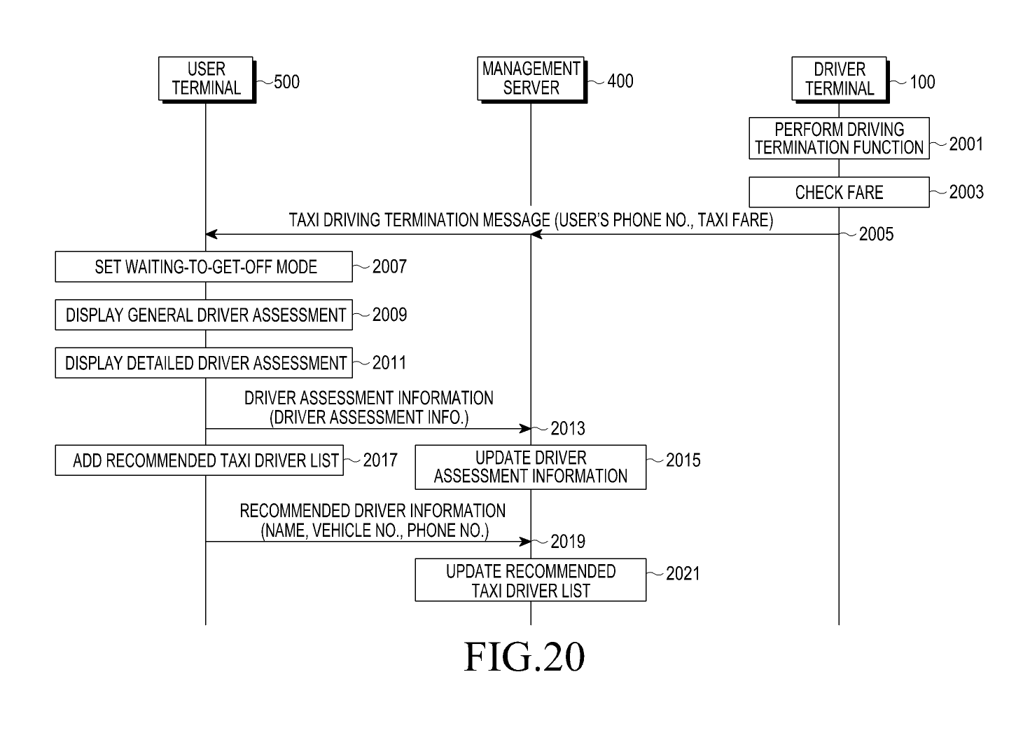

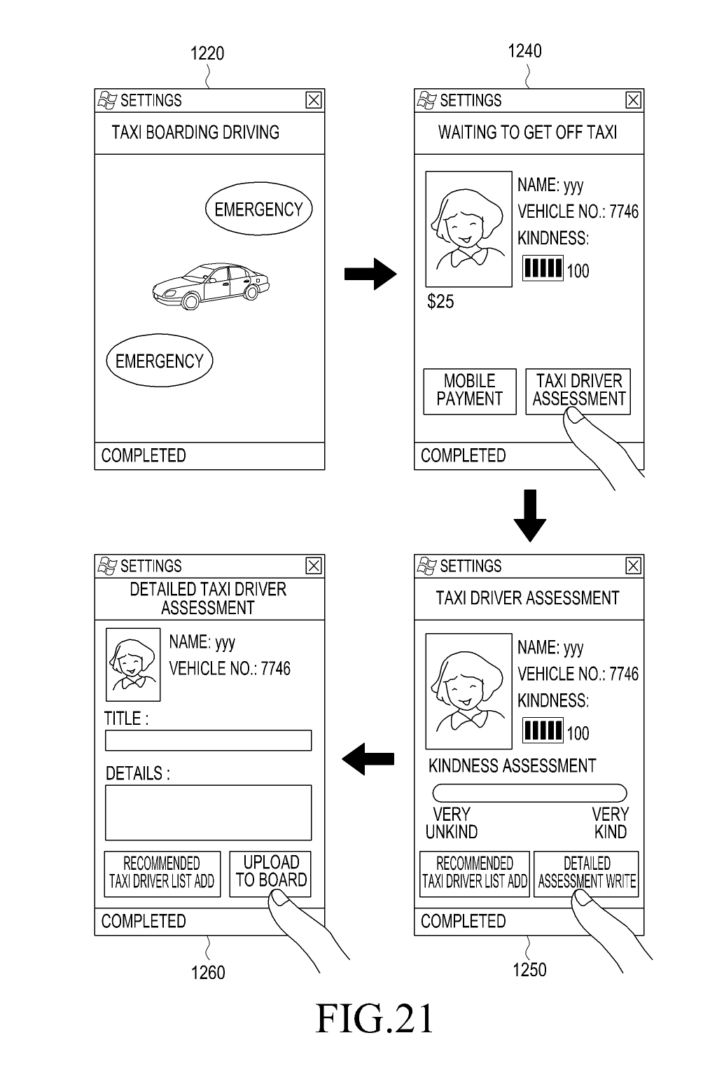

FIG. 20 is a signal flow diagram illustrating a driver assessment process according to an embodiment of the present invention, and FIG. 21 illustrates driver assessment screens according to an embodiment of the present invention.

Referring to FIG. 20, upon arriving at a destination, a taxi driver inputs a driving termination request to a driver terminal 100. In step 2001, the driver terminal 100 performs a driving termination function, and in step 2003, acquires taxi fare information from a terminal holder. In step 2005, the driver terminal 100 generates a taxi driving termination message including the phone number of the user terminal 500 and the taxi fare information, and sends the taxi driving termination message to the user terminal 500 through the management server 400.

In step 2007, upon receiving the taxi driving termination message, the user terminal 500 sets a waiting-to-get-off mode and displays a waiting-to-get-off screen 1240, as illustrated in FIG. 21, which includes taxi fare information, and may also display information about the taxi driver, taxi vehicle information, and kindness level information of the taxi driver together. The waiting-to-get-off screen 1240 may also include a payment menu capable of mobile payment (M-payment), and the taxi user may pay the taxi fare by selecting the payment menu.

In step 2009, the taxi user checks the displayed screen and selects a driver assessment menu to input assessment information about the taxi driver. For example, the user terminal 500 displays a general driver assessment screen 1250 in FIG. 21, in which the taxi user inputs an assessment value associated with the kindness level of the taxi driver.

In step 2011, the taxi user may select a detailed driver assessment menu to input a detailed assessment (or comment) about the taxi driver. For example, the user terminal 500 displays a detailed driver assessment screen 1260 in which the taxi user may input a comment indicating an assessment about the taxi driver.

In step 2013, after the taxi user completes the inputting of the driver assessment information, the user terminal 500 generates a driver assessment information message including the driver assessment information input by the taxi user, and sends it to the management server 400. The driver assessment information message may include a vehicle number of the taxi, a phone number of the driver terminal 100, an assessment value associated with the kindness level, detailed comments, etc.

In step 2015, upon receiving the driver assessment information message, the management server 400 updates driver assessment information. That is, the management server 400 forwards the driver assessment information message to a driver information server, and the driver information server updates driver information of the taxi driver based on the received driver assessment information message. If the driver assessment information message includes detailed assessments, the management server 400 updates the detailed assessments of the taxi driver, stored in the management server 400. Alternatively, if driver information is stored in the management server 400, the driver information server may directly update all driver information.

In step 2017, when inputting driver assessment information, the taxi user may add the taxi driver in a recommended taxi driver list. Therefore, when providing the general driver assessment screen 1250 or the detailed driver assessment screen 1260, the user terminal 500 provides a recommended driver list add menu. By selecting the provided recommended driver list add menu, the taxi user requests to add the taxi driver currently being assessed, in the recommended taxi driver list. Upon a driver add request, the user terminal 500 adds information about the taxi driver in its driver list. A recommended driver list add request for the taxi driver is delivered to the management server 400 in step 2019, and added in the recommended taxi driver list stored in the management server 400 in step 2021.

In the foregoing embodiments, it is assumed that a phone number of a mobile terminal and a vehicle number of a taxi are provided as a phone number and a vehicle number, and are also used as identification information of a mobile terminal and identification information of a taxi. However, other kinds of identification information for the mobile terminal and the taxi may also be used. For example, an identifier uniquely assigned to the mobile terminal may be used instead of the phone number of the mobile terminal. As another example, a taxi license number of a taxi driver may be used instead of the phone number of his driver terminal. As further another example, a vehicle registration number may be used instead of the vehicle number.

In addition, the driver information stored in the servers or provided to mobile terminals, may further include vehicle information about the taxi, for example, information about car model, color, owner-driver taxi, transport company, etc.

Although it is assumed herein that a taxi call request message, a taxi call-unallowed message, a taxi call-allowed message, a taxi boarding complete request message, a taxi driving termination message, etc., are exchanged between the user terminal 500 and the driver terminal 100 through the management server 400, they may also be exchanged between the user terminal 500 and the driver terminal 100 through a public network without passing through the management server 400.

As is apparent from the foregoing description, the above-described embodiments of the present invention provide taxi service methods and apparatuses capable of actively preventing possible taxi-related crimes. In addition, the above-described embodiments of the present invention allows a taxi user to acquire information about a taxi driver before riding in the taxi, and allows the taxi user to feed back information about the taxi driver after a taxi ride.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing a taxi service in a user mobile terminal, the method comprising:
sending, by the user mobile terminal, a search request message for a taxi;
receiving, from a management server, a driver information message including a vehicle number of a taxi and assessment information about a service provided by a driver of the taxi; and
displaying the vehicle number and the assessment information for the taxi.

2. The method of claim 1, wherein sending the search request message comprises:
sending the taxi search request message through short-range communication;
receiving a taxi information message including a vehicle number of the taxi and identification information of a driver mobile terminal connected to the taxi through the short-range communication; and
sending a driver information request message including the vehicle number and the identification information to the management server.

3. The method of claim 2, further comprising:
receiving a user input selecting the taxi;
receiving a boarding complete input for the taxi;
storing the vehicle number of the specific taxi and the identification information of the driver mobile terminal as boarding vehicle information; and
sending a boarding complete request message including identification information of the mobile terminal and the identification information of the driver mobile terminal to the driver mobile terminal through the short-range communication.

4. The method of claim 1, wherein the search request message includes location information of the mobile terminal.

5. The method of claim 1, wherein the search request message includes a request for a taxi of a recommended taxi driver and identification information of the recommended taxi driver.

6. The method of claim 1, further comprising:
sending, to a driver mobile terminal of the taxi, a taxi call request message including a vehicle number of the taxi, identification information of the driver mobile terminal, identification information of the user mobile terminal, and location information of the user mobile terminal;
periodically receiving a taxi call-allowed message including location information of the driver mobile terminal from the driver mobile terminal;
updating and displaying the location information of the driver mobile terminal, included in the periodically received taxi call-allowed messages; and
upon detecting a boarding complete input for the taxi, storing the vehicle number of the taxi and the identification information of the driver mobile terminal as boarding vehicle information, and sending a boarding complete request message to the driver mobile terminal.

7. The method of claim 6, further comprising:
detecting a user input for an emergency call request; and
sending an emergency call request message including the vehicle number of the taxi, the identification information of the driver mobile terminal, the identification information of the mobile terminal and the location information of the user mobile terminal to the management server, based on the boarding vehicle information.

8. The method of claim 6, further comprising:
receiving a taxi driving termination message from the driver mobile terminal;
displaying an assessment information input screen for the driver of the taxi; and
sending, to the management server, an assessment information message including assessment information about the driver of the taxi input from the user.

9. A method for providing a taxi service in a driver mobile terminal, the method comprising:
connecting the driver mobile terminal to a terminal holder mounted in a taxi through short-range communication;
authenticating a driver of the taxi based on the driver mobile terminal;
receiving a taxi search request message; and
sending a taxi information message including a vehicle number of the taxi and identification information of the driver mobile terminal.

10. The method of claim 9, wherein authenticating the driver of the taxi comprises:
receiving a vehicle number of the taxi from the terminal holder;
receiving a password input by the driver of the taxi;
sending, to a management server, an authentication request message including the vehicle number, the password, and identification information of the driver mobile terminal;
receiving an authentication result message from the management server; and
sending an authentication success message to the terminal holder, when the is successful.

11. The method of claim 10, wherein receiving the taxi search request message comprises receiving the taxi search request message from a user mobile terminal through the short-range communication.

12. The method of claim 11, further comprising:
receiving a taxi boarding complete request message from the user mobile terminal through the short-range communication; and
when the taxi boarding complete request message includes identification information of the user mobile terminal, storing the identification information of the user mobile terminal as boarding passenger information, and setting a boarding driving mode.

13. The method of claim 9, further comprising setting a waiting-at-taxi-stand mode, when a taxi stand notification message is periodically received by the driver mobile terminal for a predetermined time.

14. The method of claim 9, wherein the taxi search request message includes radial coordinates centered on a location of a user mobile terminal, and
wherein the method further comprises: ignoring the taxi search request message, when a current location of the driver mobile terminal does not fall within the radial coordinates; and
sending a taxi information message including a vehicle number of the taxi and identification information of the driver mobile terminal to the management server, when the current location of the driver mobile terminal falls within the radial coordinates.

15. The method of claim 14, further comprising:
receiving a taxi call request message from the user mobile terminal;
sending a taxi call-unallowed message to the user mobile terminal, when the taxi is not available; and
when the taxi is available, storing identification information of the user mobile terminal included in the taxi call request message as boarding passenger information, sending, to the user mobile terminal, a taxi call-allowed message including a current location of the driver mobile terminal, the vehicle number of the taxi, and the identification information of the driver mobile terminal, periodically detecting the current location of the driver mobile terminal, and periodically sending periodic taxi call-allowed messages including the periodically detected current location to the user mobile terminal.

16. The method of claim 13, further comprising:
upon receiving a taxi boarding complete request message from the user mobile terminal,
determining whether the identification information of the user mobile terminal, included in the taxi boarding complete request message, corresponds to the boarding passenger information; and
setting a boarding driving mode, if the identification information corresponds to the boarding passenger information.

17. The method of claim 14, further comprising:
detecting a driving termination input;
acquiring fare information from the terminal holder; and
sending a driving termination message including the fare information to the user mobile terminal.

18. The method of claim 10, further comprising:
receiving, from the management server, an emergency call request message including radial coordinates centered on a location of a user mobile terminal;
when a current location of the driver mobile terminal falls within the radial coordinates, displaying a message notifying reception of the emergency call request message, and the current location of the driver mobile terminal;
upon receiving an input to perform tracking, sending a taxi guarding start message including identification information of the driver mobile terminal to the management server;
periodically receiving, from the management server, a tracking information message including periodically updated location information of the user mobile terminal; and
displaying the location information of the user mobile terminal included in the tracking information messages.

19. A method for providing a taxi service in a management server managing information about a taxi and a driver thereof, the method comprising:
receiving a taxi search request message from a user mobile terminal;
determining radial coordinates centered on a location of the user mobile terminal;
sending the taxi search request message including the radial coordinates to a driver mobile terminal connected to the taxi;
receiving, from the driver mobile terminal, a taxi information message including location information of the driver mobile terminal, identification information of the driver mobile terminal, and a vehicle number of the taxi;
acquiring assessment information about a service provided by the driver of the taxi based on the identification information of the driver mobile terminal and the vehicle number; and
sending, to the user mobile terminal, a driver information message including the assessment information, the identification information of the driver mobile terminal, the vehicle number of the taxi, and the location information of the driver mobile terminal.

20. The method of claim 19, wherein the taxi search request message includes the identification information of the driver mobile terminal and the vehicle number.

21. The method of claim 19, further comprising determining the driver mobile terminal as a destination terminal of the taxi search request message based on a recommended taxi driver list, when the taxi search request message includes a recommended taxi search request.

22. The method of claim 19, wherein determining the radial coordinates comprises:
detecting a location of the user mobile terminal from the taxi search request message, when the taxi search request message includes location information of the user mobile terminal;
determining the location of the user mobile terminal, when the taxi search request message does not include the location information of the user mobile terminal; and
determining radial coordinates having a radius centered on the location of the user mobile terminal.

23. The method of claim 19, further comprising:
receiving an emergency call request message from the user mobile terminal;
determining radial emergency coordinates centered on a current location of the user mobile terminal;
sending an emergency call request message including the radial emergency coordinates to a guard terminal;
receiving a taxi guarding start message from the guard terminal;
registering the guard terminal in a tracking list;
periodically detecting a location of the user mobile terminal; and
periodically sending tracking information messages including the periodically detected location of the user mobile terminal to the guard terminal registered in the tracking list.

24. The method of claim 19, further comprising:
receiving an assessment information message including new assessment information about the driver of the taxi, from the user mobile terminal; and
updating the assessment information about the driver of the taxi using the new assessment information.

25. A user mobile terminal for providing a taxi service, the user mobile terminal comprising:
a wireless communication unit for performing communication with a management server;
a display for displaying data; and
a controller for controlling the wireless communication unit and the display, generating a search request message for a taxi, sending the search request message through the wireless communication unit, receiving, from the management server through the wireless communication unit, a driver information message including a vehicle number of a taxi and assessment information about a service provided by a driver of the taxi, and displaying the vehicle number and the assessment information for the taxi on the display.

26. A driver mobile terminal for providing a taxi service, the driver mobile terminal comprising:
a short-range communication module for performing short-range communication;
a wireless communication unit for performing communication with a management server;
a Global Positioning System (GPS) module for detecting a location of the driver mobile terminal;
a display for displaying data; and
a controller for controlling the short-range communication module, the wireless communication unit, the GPS module, and the display, connecting the driver mobile terminal to a terminal holder mounted in a taxi through the short-range communication module, authenticating a driver of the taxi based on the driver mobile terminal, and upon receiving a taxi search request message, generating a taxi information message including a vehicle number of the taxi and identification information of the driver mobile terminal.

27. A management server for managing information about a taxi and a driver thereof, the management server comprising:
a communication unit for performing communication;
a memory for storing data; and
a controller for controlling the communication unit, receiving a taxi search request message from a user mobile terminal through the communication unit, determining radial coordinates centered on a location of the user mobile terminal, sending the taxi search request message including the radial coordinates to a driver mobile terminal connected to the taxi through the communication unit, receiving a taxi information message including location information of the driver mobile terminal, identification information of the driver mobile terminal, and a vehicle number of the taxi from the driver mobile terminal through the communication unit, acquiring assessment information about a service provided by the driver of the taxi based on the identification information of the driver mobile terminal and the vehicle number, generating a driver information message including the assessment information, the identification information of the driver mobile terminal, the vehicle number of the taxi, and the location information of the driver mobile terminal, and sending the driver information message to the user mobile terminal through the communication unit.
